(19) United States
(12) Patent Application Publication
(10) Pub. No.: US 2006/0116131 A1
(43) Pub. Date: Jun. 1, 2006

(54) Reporting satellite positioning system assistance integrity information in wireless communication networks

(76) Inventors: Scott D. Morgan, Lake in the Hills, IL (US); Gabriel B. Burca, Palatine, IL (US); William P. Declerck, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 10/999,417

(22) Filed: Nov. 30, 2004

(51) Int. Cl. H04Q 7/20

(52) U.S. Cl. 455/456.1; 455/12.1

(57) ABSTRACT

A wireless communication device (102) including a satellite positioning system (SPS) receiver (104), and a wireless transceiver (106) communicably coupled to the satellite positioning system receiver. The wireless transceiver for receiving satellite positioning system assistance information, for example, SPS reference time, from a wireless communication network, and for transmitting integrity information, for example, SPS reference time offset, for the satellite positioning system assistance information received.

### FIELD OF THE DISCLOSURE

The present disclosure relates generally to wireless communications, and more particularly to wireless communication networks that provide satellite positioning system (SPS) assistance information to SPS enabled mobile communication devices, SPS enabled mobile stations and methods.

### BACKGROUND OF THE DISCLOSURE

Satellite positioning system (SPS) receivers, for example, NAVSTAR Global Positioning System (GPS) receivers, are used widely for navigation and have substantial potential to provide location information in mobile wireless communication devices, including cellular telephones, which must soon comply with United States Federal Communications Commission E-911 location requirements. Satellite positioning system receiver enabled cellular telephones will also advance the growth of location based commerce.

Satellite positioning system (SPS) receivers compute navigation solutions using navigation data message information modulated on satellite carrier signals. Obtaining the navigation information directly from the satellites however is time consuming. In the NAVSTAR Global Positioning System (GPS), for example, the navigation message data is transmitted at 50 bits per second (BPS). At this rate, in a good signal environment, approximately 30 seconds are required to obtain ephemeris data for a particular satellite and approximately 12 minutes are required to obtain almanac data. GPS reference time may be obtained by demodulating a satellite signal, but this also requires substantial time. These delays are exacerbated by the portable nature of GPS receiver equipped cellular telephones, which are often used while traveling in urban canyons, in buildings and in other environments that obstruct or significantly degrade satellite signal strength and/or quality. To address the delay issue, it is known for cellular communication networks to provide satellite positioning system assistance information, for example, GPS reference time, code phase, Doppler, ephemeris, almanac and other information, to GPS receiver equipped cellular telephones in messages sent over the cellular communication network. See, for example, U.S. Pat. No. 6,064,336 entitled ‘GPS Receiver Utilizing A Communication Link” and U.S. Pat. No. 6,134,483 entitled “Method And Apparatus For Efficient GPS Assistance In A Communication System”.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary wireless communication network that provides satellite positioning system (SPS) assistance information to SPS enabled wireless communication devices.

FIG. 2 is an exemplary process flow diagram.

FIG. 3 is an exemplary communication sequence in a communication network implementing a mobile station-assisted location protocol.

FIG. 4 is an exemplary communication sequence in a communication network implementing a mobile station-based location protocol.

### DETAILED DESCRIPTION

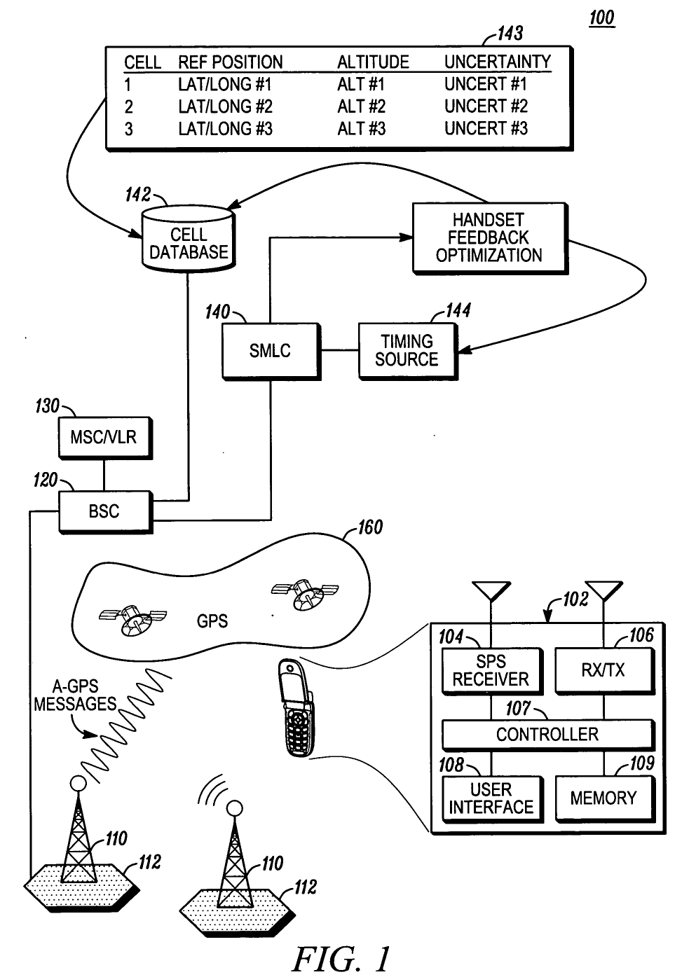

FIG. 1 illustrates an exemplary wireless communication system 100 for providing satellite positioning system (SPS) assistance information to an SPS enabled mobile communication device 102 comprising generally a radio access network and a core network. The SPS enabled mobile communication device 102 generally comprises an SPS receiver 104 integrated or combined as an accessory with a wireless communication device comprising a radio or other frequency transceiver 106 coupled to a controller 107 coupled to user inputs and output 108, which include a display, keypad inputs, etc., and to memory 109 as is known by those of ordinary skill in the art. The wireless communication device may be compliant with an open standard or proprietary cellular or non-cellular communication protocol, examples of which are discussed further below.

The exemplary radio access network includes a plurality of base transceiver stations (BTSs) 110 for providing wireless communication coverage to the wireless mobile station 102 in a patchwork of generally contiguous corresponding cellular areas 112. The radio access network also includes one or more base station controllers 120 communicably coupled to corresponding sets of one or more base transceiver stations. The exemplary core network includes a mobile switching center and location register (MSC/VLR) 130 communicably coupled to one or more base station controllers 120. The mobile switching center is communicably coupled to a public switched telephone network (PSTN) not illustrated but known by those of ordinary skill in the art. In some embodiments, the core network also includes a Packet Data Serving Node (PDSN) gateway between the radio network and a core packet network, which are known generally by those of ordinary skill in the art.

In FIG. 1, the exemplary wireless communication system 100 also includes a serving mobile location center (SMLC) 140 for supporting location services (LCS) functionality. The SMLC manages the co-ordination and scheduling of resources required for locating mobile stations within the network. In some network architectures, the SMLC computes and estimates the accuracy of location solutions using pseudorange information obtained from SPS enabled mobile stations. In FIG. 1, the exemplary SMLC 140 is a separate entity, though in other network architectures it may be integrated with a base station controller or with some other infrastructure entity.

In FIG. 1, the wireless communication system 100 includes a cell database 142 containing surveyed reference position data for each wireless cell site 110 in the network. At block 143, for example, the cell database includes latitude and longitude location information for each base station, corresponding altitude and uncertainty information, for example, uncertainty ellipsoid information, along with a current reference time offset for each cell site. The reference time offset compensates for delay in the communication of SPS time to the cell site, as discussed more fully below.

Exemplary wireless communication networks include a Global System for Mobile Communications (GSM) protocol network, a 3^{rd} Generation (3G) Universal Mobile Telecommunications System (UMTS) W-CDMA protocol network, one of the several varieties of CDMA protocol networks, among other cellular networks including satellite communication networks, or a future generation wireless communication protocol network, or combination thereof. And although the exemplary communication networks are cellular networks, the instant disclosure is also applicable to non-cellular wireless communication systems over which SPS assistance information is transmitted to one or more wireless communication devices. The present disclosure is not limited, however, to any particular wireless communication network.

In FIG. 1, the mobile station 102 and particularly the SPS receiver thereof, navigates or computes position information based on signal received from one or more satellites of a positioning system (SPS) constellation 160. Exemplary earth-bound SPS constellations include, but are not limited to, the NAVSTAR GPS, GLONASS SPS and the proposed Galileo SPS. More generally the SPS constellation may orbit a celestial body other than earth, for example, a moon, or other planet. The instant disclosure is not limited to any particular type of SPS constellation or system. In one embodiment, SPS navigation information is obtained, for example, by a terrestrial reference entity communicably coupled to the wireless communication network as is known generally by those of ordinary skill in the art.

In some embodiments, generally, the wireless communication network transmits SPS assistance information to the location functionality of the wireless communication device, for example, to speed position information computation to comply with E-911 location requirements. In FIG. 1, for example, SPS assistance information, for example, an assistance message, is transmitted from the base transceiver station 110 to the wireless mobile station 102 over the wireless communication interface. The wireless communication device 102 and particularly the SPS receiver 104 uses the assistance information to acquire and track satellites, and in some embodiments to compute pseudorange information and position solutions, and to perform other functions as is known generally by those of ordinary skill in the art. In some applications, the wireless communication device computes and returns a position solution to the communication network, and in other applications the network computes the position solution using pseudorange information obtained from the SPS receiver.

The specific content of the assistance information is dependent on the particular application. In some cellular communication networks, the content of the SPS assistance message is specified by various communication standards protocols. Exemplary assistance information includes, but is not limited to, ephemeris, SPS time, code phase and Doppler information, some of which is obtained by the network directly or indirectly from SPS satellites. Assistance information includes information not obtained from the satellites that may assist the location determining functionality of wireless communication device 102. Exemplary information includes the approximate position and/or altitude of the device 102. In one embodiment, the approximate position and/or altitude information is the location of the cell site to which the device is most nearly located as obtained from the cell database 142 discussed above.

In FIG. 1, a timing source 144 that obtains SPS satellite time for communication to the wireless communication device 102. In one embodiment, the timing source derives current SPS time from a network time protocol (NTP) server. Alternatively, SPS time may be obtained directly from an SPS signal. The timing source 144 must generally adjust the SPS time to compensate for network delay in transmission to the mobile station, for example, using time offset information obtained from the cell database or from some other source, as discussed more fully below. The compensated SPS reference time is referred to herein as GPS or SPS reference time.

In one embodiment, the SPS enabled wireless communication device reports satellite positioning system assistance integrity information to the wireless communication network. The integrity information could be explicit information and in other embodiments it is implied in or by some other information that the wireless communication device reports to the network. The network may use the integrity information to correct or adjust the assistance information and to isolate sources of error or inaccuracy.

In some location architectures, the wireless communication device requires accurate SPS time to aid computing a position solution and/or pseudoranges. For coarse time aiding it is important for the SPS time to be accurate to within a certain range (e.g. ±2 seconds). For more precise aiding, it may be desirable to reduce the accuracy to within ½ a data bit period of the satellite signal. As discussed above, there is generally some delay associated with communicating SPS time over a wireless communication network. Some delay is fixed, and other delay varies with time and location. The network must therefore compensate for the delay by adjusting the SPS time, for example, based on the particular cell site offset, but the compensation is not always accurate. The compensated SPS reference time is referred to herein as SPS reference time.

Thus in one embodiment, the signaling between the network and wireless communication device is enhanced to provide SPS reference time integrity information to the network, for example, in the form of an offset time as measured by the SPS receiver in the wireless communication device. The network can utilize the integrity information to isolate sources of position solution inaccuracy, and in some embodiments to dynamically re-adjust the SPS reference time subsequently provided by the network. In FIG. 1, for example, the network may use the offset time received from the wireless communication device 102 to update the offset corresponding to a particular base station or cell site stored in the cell database 142, wherein the integrity is communicated from the SMLC 140 to the cell data base 142 and/or to the timing source 144.

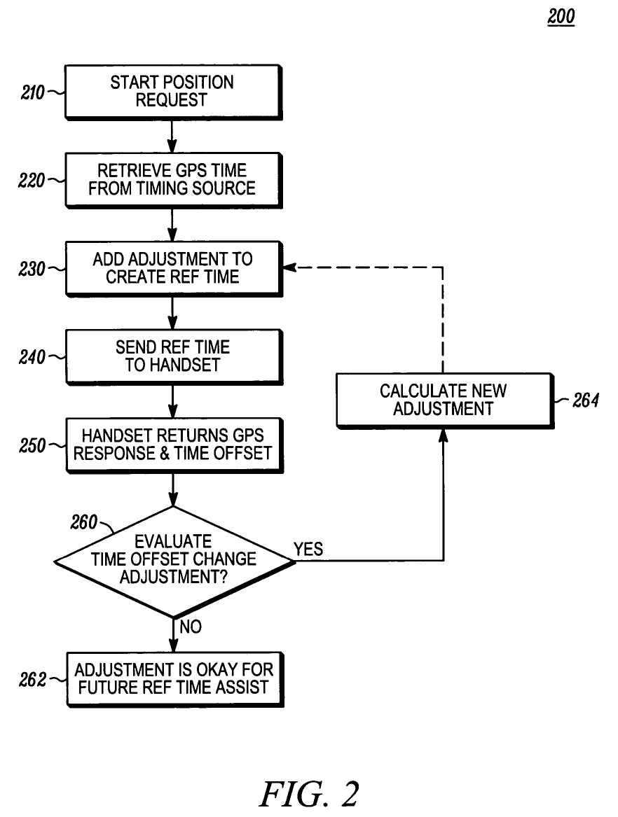

In the exemplary process diagram 200 of FIG. 2, at logical block 210, a position request protocol is initiated, for example, upon making an emergency call, e.g., an E-911 call, or upon requesting or using a location based service that requires a location update or location information. In some embodiments, the request is initiated at or by the mobile station, and in other embodiments the request is initiated at or by the network. At block 220, the network retrieves SPS time from a timing source, for example, the timing source 144 in FIG. 1 as discussed above. At block 230, the SPS time is adjusted to create an SPS reference time that compensates for transmission delay between the network and the wireless communication device. At block 240, the SPS reference time is sent to a wireless communication device, for example, as part of an assistance message. At block 250, the wireless communication device returns time offset information to the wireless communication network along with other location information, for example, position solution or pseudorange information for use by the network in computing a position solution.

In one exemplary embodiment where the wireless communication device returns time offset information to the wireless communication network, the offset time information is determined at the wireless communication device by comparing the adjusted SPS reference time received from the network to the actual SPS time determined at the wireless communication device. In FIG. 1, this comparison may be performed by the SPS receiver 104 or by the controller 107. Schemes for accurately determining SPS time at an SPS receiver are known generally by those of ordinary skill in the art. The SPS enabled wireless communication device thus determines the error of the SPS reference time provided by the network using the accurate SPS time determined by the SPS receiver. It is likely to be the SPS receiver that will determine the error. In FIG. 1, integrity information is communicated by the wireless communication device using the wireless transceiver 106.

In FIG. 2, at block 260, the network evaluates the time offset information received from the wireless communication device and determines whether to re-adjust the SPS reference time. At block 264, a new adjustment is calculated. At block 230, the network computes a new re-adjusted SPS reference time based on the new adjustment computed at block 264. Thereafter, the network provides the re-adjusted SPS reference time to wireless communication device and/or other devices requiring time assistance. In some embodiments, the network thus dynamically re-adjusts the SPS reference time based on offset time information obtained from SPS enabled wireless communication devices.

In FIG. 2, at block 230, the adjustment of the SPS time to create the SPS reference time at block 230 is generally dependent on network delay, which may in turn depend on distance, network traffic and other factors. Thus the adjustment is generally different for different parts of the network, for example, for different cell sites or location areas (LAs) within a public land mobile network (PLMN). In the exemplary cell data base of FIG. 1, each cell site has a corresponding SPS offset time. Similarly, the re-adjustment of the reference time based on the offset time information may also be limited to a particular geographical area, for example, a particular location area (LA) in which the SPS enabled device providing the time offset information is located.

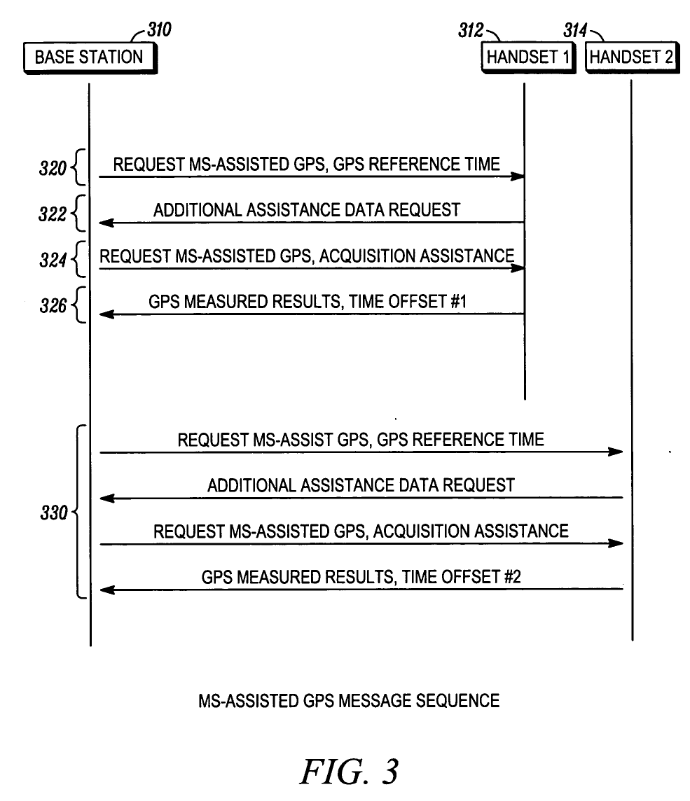

FIG. 3 illustrates an exemplary sequence of communications between a base station 310 and wireless mobile station (MS) (Handset 1) 312 in a wireless communication network that implements a MS-assisted GPS location protocol. Under the MS-assisted protocol, the position solution is computed at the network using information provided by the MS. At 320, the handset 312 receives MS-assisted location request information including SPS reference time from the base station 310. In some embodiments, at 322, the handset 312 requests additional assistance information. At 324, the base station transmits another MS-assisted location request and sends acquisition assistance information to the handset 312. At 326, the handset 312 sends pseudorange measurement results and offset time information to the base station. The offset information is used by the network to improve the SPS reference time, which may be subsequently transmitted to the handset 312 and to other handsets, for example, handset 314 in FIG. 3. Generally, the handset 314 receives location request and assistance information from the base station 310 at 330. The handset 314 subsequently returns the request location information and SPS time offset information at 332. In some instances, the network may send another location request to the handsets after receiving the initial measurement results.

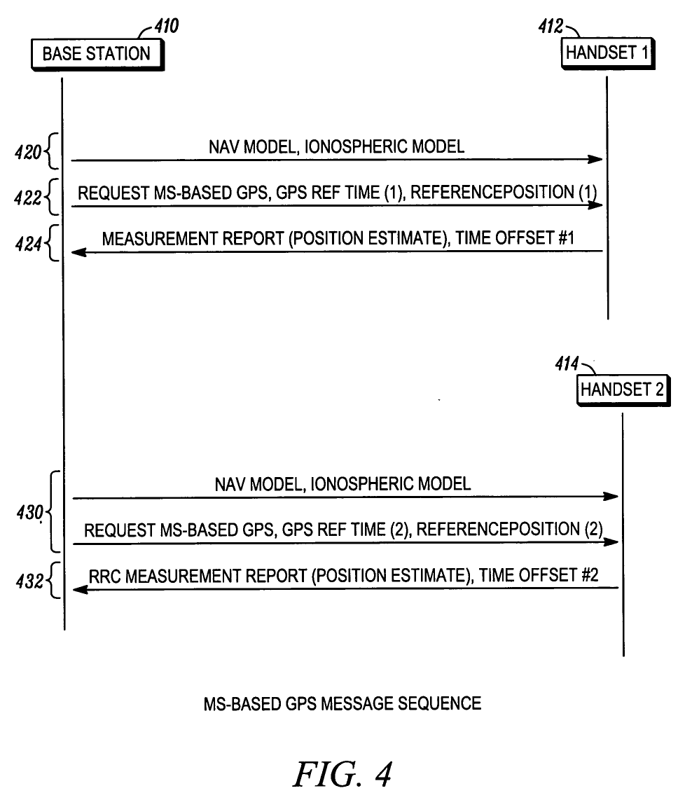

FIG. 4 illustrates an exemplary sequence of communications between a base station 410 and a wireless mobile station (Handset 1) 412 in a wireless communication network that implements a MS-based SPS location protocol, wherein the position solution is computed at the MS. At 420, the base station 410 sends GPS satellite navigation and ionospheric modeling information to the MS 412. At 422, the base station sends a location request along with reference position and GPS reference time information to the MS 412. At 424, the MS 412 sends a position estimate report and time offset information to the base station. Thereafter, the base station may use the offset information to re-adjust the reference time, as discussed above in connection with FIGS. 1 and 2. The offset information is used by the network to improve the SPS reference time, which may be subsequently transmitted to the handset 412 and to other handsets, for example, handset 414 in FIG. 4. Generally, the handset 414 receives location request and assistance information from the base station 410 at 430. The handset 414 subsequently returns the request location information and SPS time offset information at 432. In some instances, the network may send another location request to the handsets after receiving the initial position measurement results.

More generally, the wireless communication device may report integrity or error information for assistance information other than SPS reference time. The wireless communication device may, for example, determine the integrity or error for approximate position and/or altitude information provided by the network after computing a position solution. Other types of assistance information for which the wireless communication device provides integrity information includes, but is not limited to, satellite positioning system navigation modeling information, for example, ephemeris and/or almanac data, satellite positioning system acquisition information.

In other embodiments, the integrity of navigation modeling information is communicated from the wireless communication device to the network. The SPS receiver may decide to reject a navigational model for one or more satellites if it is determined that the navigation model information is older than information that the SPS receiver is able to acquire from another source or because the modeling information is too old. In this case it may be necessary for the SPS receiver to acquire the navigation modeling information from another source, for example, directly from the satellite. Thus in some embodiments, the wireless communication device reports the integrity of assistance information by indicating whether the assistance information is relevant. For example, in applications where the network sends ephemeris data, which degrades quickly over a period of a few hours, the wireless communication device may indicate to the network that the ephemeris data is outdated.

In another embodiment, the network determines the integrity or quality of SPS reference position and/or reference altitude information provided based on the measurement report received from the mobile station. In some embodiments, the network adjusts approximate positioning uncertainty parameters, for example, ellipsoid size and shape, dynamically based on measurement reports received from mobile stations served by the base station. Similar adjustments may be made for altitude information. The reference position and/or altitude information is thereby self-calibrated and fine-tuned.

Although the exemplary embodiments discussed above are drawn to satellite positioning system based location schemes, the disclosure is more generally application to any location scheme where the wireless communication device received location assistance information for assisting the wireless communication device in obtaining information for determining its location. Other location schemes include Enhanced Observed Time Difference (E-OTD). In (E-OTD) location applications, a serving base station provides the wireless communication device with location assistance information in the form of base station identity and corresponding frequency and expected time difference information. The E-OTD enabled mobile wireless communication device uses the location assistance information to acquire the identified base station signals. The location assistance integrity information reported by the wireless communication device to the network may be the observed time difference or an error between the expected and observed time differences. In other location schemes, other location assistance information is provided to the mobile wireless communication device, and corresponding integrity information is sent to the network.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication device capable of communicating with a wireless communication network, the method comprising:
receiving location assistance information from the wireless communication network,
the location assistance information for assisting the wireless communication device in obtaining information for determining a location of the wireless communication device;
reporting integrity information for the location assistance information to the wireless communication network.

2. The method of claim 1, the wireless communication device is a satellite positioning system enabled wireless communication device,
receiving location assistance information includes receiving satellite positioning system assistance information,
the satellite positioning system assistance information for assisting the satellite positioning system enabled wireless communication device in obtaining satellite positioning system information;
reporting integrity information includes reporting satellite positioning system assistance integrity information to the wireless communication network.

3. The method of claim 2, reporting satellite positioning system assistance information integrity includes determining error information for the satellite positioning system assistance information.

4. The method of claim 2,
reporting satellite positioning system assistance information integrity includes reporting integrity information for one of
satellite positioning system reference time information,
approximate position information for the satellite positioning system enabled wireless communication device,
satellite navigation modeling information.

5. The method of claim 2, reporting satellite positioning system assistance information integrity includes reporting relevance information for the satellite positioning system assistance information.

6. The method of claim 2, reporting satellite positioning system assistance information integrity includes reporting quality information for the satellite positioning system assistance information.

7. The method of claim 2,
receiving satellite positioning system assistance information from the wireless communication network includes receiving satellite positioning system reference time information,
satellite positioning system reference time information is satellite positioning system time compensated for network delay,
reporting satellite positioning system assistance information integrity includes reporting satellite positioning system reference time offset information to the wireless communication network.

8. The method of claim 1,
receiving location assistance information includes receiving any one of
satellite positioning system reference time information,
satellite positioning system navigation modeling information,
approximate position information for the wireless communication device;
signal acquisition information.

9. The method of claim 1,
receiving location assistance information includes receiving location signal acquisition information and expected time difference information,
reporting integrity information includes reporting observed time difference information for the location signal acquisition information.

10. A method in a wireless communication network that transmits location assistance information to a wireless communication device, the method comprising:
transmitting location assistance information from the wireless communication network to the wireless communication device;
receiving location assistance integrity information, from the wireless communication device, for the location assistance information transmitted to the wireless communication device.

11. The method of claim 10, adjusting location assistance information provided by the wireless communication network after receiving the location assistance integrity information from the wireless communication device.

12. The method of claim 11,
transmitting the adjusted location assistance information from the wireless communication network to a wireless communication device.

13. The method of claim 10,
transmitting location assistance information includes transmitting adjusted satellite positioning system time,
receiving location assistance integrity information includes receiving adjusted satellite positioning system time offset information.

14. The method of claim 13, re-adjusting the satellite positioning system time based on the offset information received from the wireless communication device.

15. The method of claim 10,
receiving location assistance integrity information includes receiving location measurement information,
adjusting approximate position uncertainty parameters based on the location measurement information received from the wireless communication device.

16. The method of claim 10,
receiving location assistance integrity information includes receiving satellite positioning system location measurement information,
adjusting altitude uncertainty information based on the satellite positioning system location measurement information received from the wireless communication device.

17. A mobile wireless communication device, comprising:
a wireless transceiver capable of communicating with a wireless communication network;
the wireless transceiver including a wireless receiver for receiving location assistance information from the wireless communication network,
the location assistance information for assisting the mobile wireless communication device in obtaining information for determining a location of the mobile wireless communication device; and
the wireless transceiver including a transmitter for transmitting location assistance integrity information for the location assistance information received from the wireless communication network.

18. The wireless communication device of claim 17,
a satellite positioning system receiver communicably coupled to the wireless transceiver;
the location assistance information received is satellite positioning system time compensated for network delay,
the wireless communication device for determining an offset for the compensated satellite positioning system time, the location assistance integrity information is the offset for the compensated satellite positioning system time,
the transmitter for transmitting the offset for the compensated satellite positioning system time.

19. The wireless communication device of claim 17,
the wireless communication device for determining the integrity of the satellite positioning system assistance information before transmitting the location assistance integrity information to the wireless communication network.
